(19) United States
(12) Patent Application Publication
(10) Pub. No.: US 2003/0212640 A1
(43) Pub. Date: Nov. 13, 2003

(54) Universal product attribute modeler

(76) Inventors: Hans Magnus Andresen, Munich (DE); Aarif Nakhooda, Munich (DE); Jon Lipsky, Munich (DE)

Correspondence Address: BAKER & MCKENZIE, 805 THIRD AVENUE, NEW YORK, NY, 10022, US

(21) Appl. No.: 10/137,514

(22) Filed: May 1, 2002

(51) Int. Cl. G06F 17/60

(52) U.S. Cl. 705/64

(57) ABSTRACT

The method and system for universal product attribute modeler for facilitating product matching among different parties such as buyers and suppliers is provided. Each party's attribute-based product description and unique identification code are loaded into a model. Any one party may request a product from any other party, using its own unique identification code regardless of what the other parties use for identifying the same or similar product. When a party requests a product using its own unique identification code, the universal product attribute modeler converts the unique identification code into generic attribute description, searches the model for matching product from the other parties, and when found communicates the request to those parties found in the search. The request is communicated using the other parties' unique identification codes that may be different from the requesting party's identification code.

### TECHNICAL FIELD OF THE INVENTION

The present invention generally relates to supply chain management, and in particular to providing a data model that standardizes a plurality of product descriptions used by suppliers and buyers to allow communication of their product specifications easily and accurately. Although the invention is applicable to any product that can be described by its attributes, the invention is discussed in terms of the plurality of paper descriptions as one example for which the invention is valid.

### BACKGROUND OF THE INVENTION

In the paper and pulp industry, each vendor, mill, and buyer company refers to paper products by its own codes, brand names, item numbers, or stock-keeping units (“SKUs”). This non-standardized way of identifying paper products among different players in the paper and pulp market place has necessitated and continues to necessitate, multiple mappings of identifiers for the same products. For example, if a buyer desires to buy a product having X, Y, Z attributes, and there are multiple vendors offering products with these attributes, the buyer needs to know or keep a record of each vendor's product identifier for such products specific to each vendor. In addition, if the buyer does not know of an identifier used by a specific vendor, the buyer would not have an option to consider other vendors who may offer similar products that the buyer needs. Therefore, it is highly desirable to have a uniform way of describing paper among the paper and pulp industry players where buyers and suppliers can communicate their needs without knowing what the buyers and suppliers call these products.

Although electronic tools promise to enhance communication, improve production planning, expand market coverage, and increase productivity, the paper and pulp industry has been unable to successfully harness the technology because paper producers and paper consumers such as mills and converters use different product identifiers such as different SKUs to describe like products. Converters are manufacturing plants that use paper to make paper-based products, such as packaging or consumer products. Therefore, there is a need to have a uniform way of describing paper among the paper and pulp industry players.

### SUMMARY OF THE INVENTION

In one aspect, a method is provided for a universal product attribute modeler for facilitating e-commerce, for example, in the paper and pulp industry. The method comprises receiving vendor specific description for one or more paper products. The vendor specific description is converted to a uniform description based on its basic attribute components and stored with the associated vendor in a data model. The data model may be a relational database model. The data model may then be used by a buyer to search for specific products. For example, a buyer specific description for one or more paper products is received and converted to a uniform description. This uniform description is used to query the data model. When found, the paper product description and one or more vendors offering the paper product are provided. In this way, a buyer looking for a specific paper product may search for a number of available paper products and vendors by only entering the buyer specific code or description. In addition, a buyer need not know how each vendor identifies different paper products.

Similarly, a supplier making a product offering may utilize the universal product attribute modeler to post its product by its own unique identifier and search for buyers who are looking for the products that the supplier is offering.

In another aspect, the data model identifies similar products by their attributes such as size, color, brightness, tensile strength, rather than by SKUs. This method of identifying products allows for more accurate mapping of products for buyers and suppliers.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 is a flow diagram illustrating product and attribute loading in one embodiment;

FIG. 2 is a flow diagram illustrating product and attribute web loading in one embodiment;

FIG. 3 is a flow diagram illustrating a buyer centric matching process in one embodiment;

FIG. 4 is a flow diagram illustrating a supplier centric matching process in one embodiment;

FIG. 5 is an architectural diagram illustrating software components that implement the method and system of universal product attribute modeler in one embodiment;

FIG. 6 is an example of an entry form in one embodiment; and

FIG. 7 shows an example of how an application layer translates a user request into search criteria in one embodiment.

### DETAILED DESCRIPTION OF THE INVENTION

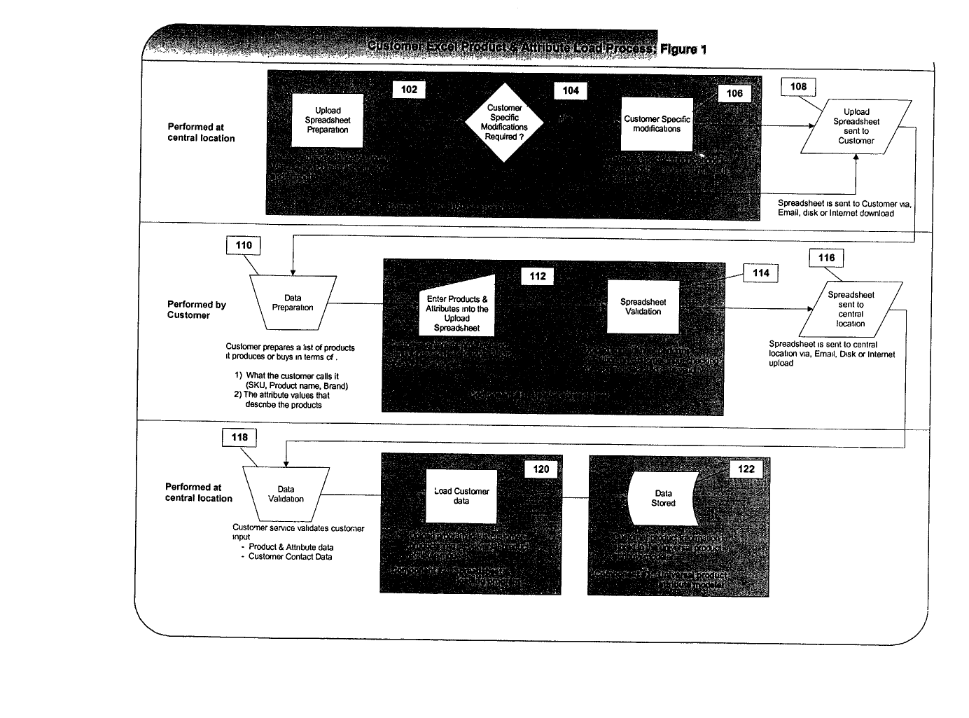

FIG. 1 is a flow diagram illustrating product and attribute loading in one embodiment. At 102, an entry form that customers may enter their product attributes is prepared. The entry form, for example, may be in a form of a user-friendly spreadsheet application program that allows product buyers and suppliers, for example, forest or paper product buyers and suppliers, to describe the paper products that they buy and sell.

The spreadsheet application, for example, may capture the buyer or supplier's unique identifiers identifying their products. These identifiers may be both internal and external. Internal identifiers may include the buyer's or supplier's stock-keeping unit (“SKU”), item number, product code, etc. External identifiers may include the product name and brand. The spreadsheet may additionally capture those product attributes that make each supplier or buyer unique. The spreadsheet may contain over 1,000 attributes to describe up to 500 paper products for 13 forest product verticals. Each vertical represents an industry-accepted category of forest products. Some example verticals are newsprint, printing & writing, market pulp-bale, and tissue.

At 104, a determination is made as to whether the spreadsheet needs further customization for a specific customer. For example, a customer may have one or more unique attributes specific to that customer's products only. At 106, if it is determined that further customization is necessary, the spreadsheet is further modified, for example, to include additional attributes.

The entry forms such as the spreadsheet may be tailored or customized to meet specific user's functions and requirements. In addition, based on who is using the entry form, the entry forms such as spreadsheets may be called different names. For example, when a spreadsheet is sent to a paper mill, it may be called the supplier spreadsheet. The same spreadsheet may be called the buyer profile spreadsheet when sent to paper procurement personnel. The spreadsheet may also be customized to include the tailored look and feel for a specific customer. This look and feel may, for example, include customers logos, colors, etc. Regardless of the name and customization, however, the same core spreadsheet, or entry form, may be used for describing product attributes for suppliers and buyers.

At 108, the entry form, for example, a spreadsheet, is sent to a customer, for example, by electronic mail, on a disk by postal service, or via downloading over the Internet. Those skilled in the art should understand that using a spreadsheet is not the only method for receiving attribute information from the customers. Instead, any other known method for communicating data may be used. For example, the attribute data may be included in a flat computer file, database file, word processor file, etc., and communicated to the modeler. Additionally, attribute data may be entered through a form on a computer display screen, or any other known method for inputting data. At 110, a customer prepares a list of products it produces or buys in terms of, for example, customer specific identifier such as SKU, product name, and brand name, and the attribute values that describe the products. For paper products, these attribute values may include weight, color, grammage, opacity, gloss, coating, dirt, density, porosity, bulk, stiffness, tear, etc.

At 112, the customer enters its products and attribute-based descriptions into the spreadsheet or entry form. At 114, data entered is validated. The validation, for example, may be performed by the spreadsheet. In cases where other entry forms are used, appropriate data checking programs associated with the entry forms may be used. For example, if a web browser is used, scripting code segments may be used to validate data. The validation may include checking for mandatory entries, for example, product description parameters, and data form entries, for example, date format and numeric formats.

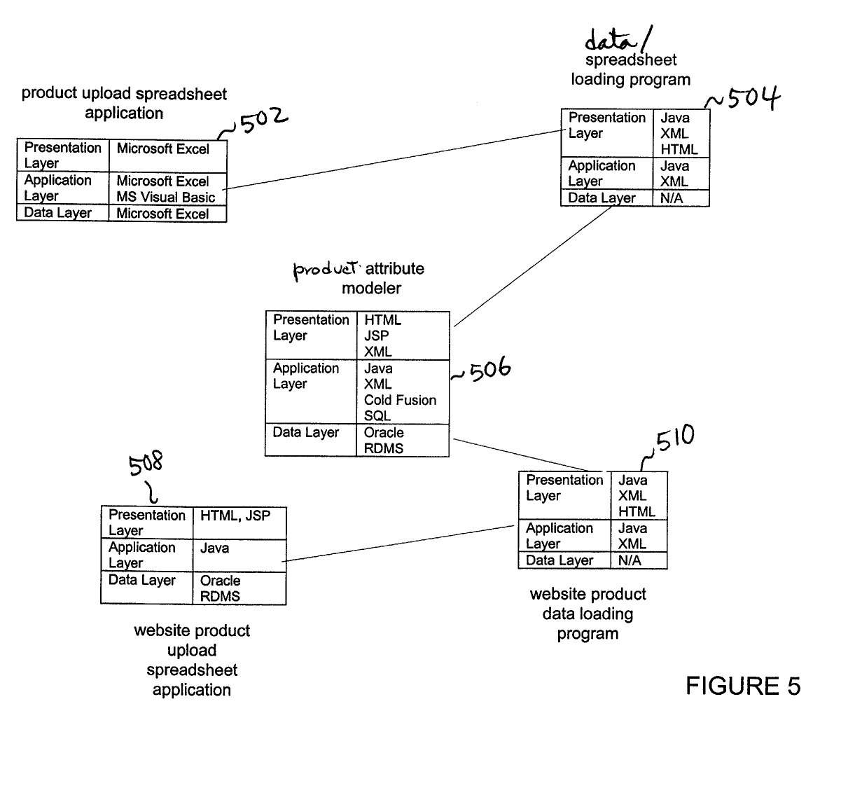

At 116, the completed spreadsheet or data entry form is sent back to the universal product attribute modeler, for example, via e-mail, Internet uploading, or on a disk. The universal product attribute modeler herein is described with respect to paper product; however, it should be understood that any other products may be described uniformly using the universal product attribute modeler. At 118, when the universal product attribute modeler receives the entry data, the universal product attribute modeler verifies data entered into the spreadsheet. This verification includes checking the context of the data, and making sure that the data is valid. For example, brightness is expressed in terms of percentage. Accordingly, if a number greater than 100 is entered, the input data is flagged as an error. Other illustrative examples of data verification may include checking for basic required fields such as product type, grade, grammage, caliper, width, and length, and checking for data formats such as numerical fields. At 120, the attribute data is loaded into the universal product attribute modeler. The loading may take place directly from the entry form, for example, the spreadsheet. The loading may be performed, for example, by a loading program shown in FIG. 5. The loading program extracts product and attribute information captured by the uploaded data entry form, for example, the uploaded spreadsheet. The loading program loads the extracted data into the universal product attribute modeler. The universal product attribute modeler, for example, may be a relational database. An example of a product upload spreadsheet is a stand-alone Microsoft Excel based application. This application may include, for example, a presentation layer, application layer, and data layer. The application layer may further be coded using Microsoft Visual Basic program. One skilled in the computer programming art will know that software programming in modular layers is commonly used, and therefore such methods will not be described in detail herein.

At 122, the customer product information is stored in the universal product attribute modeler. The universal product attribute modeler allows for one-time mapping of each manufacturer's and customer's product catalogues to the universal product attribute modeler. A model in the universal product attribute modeler may describe, for example, over 500 grades of paper products using over 1000 attributes. The model allows customers the unique ability to consolidate like products from multiple suppliers by grouping like products based on a set of attributes and values. With this model, a customer need not manage multiple SKUs of multiple suppliers or buyers. For each buyer, the needed or requested product is automatically mapped to what each supplier can produce. For each supplier, what the supplier desires to sell is automatically mapped to each buyer at each location. In addition, the universal product attribute modeler may include standardized product descriptions by using generic attribute descriptors.

For example:

Paper Company X has a product called Velocity paper under its Coated Freesheet #3 grade. Its attributes are described by:

Basis Weight: 50#-100#

Opacity: 90.5-96

Brightness: 81-82

Paper Company Y has a product called Utopia III under its Coated Freesheet #3 grade. Its attributes are described by:

Basis Weight: 45#-100#

Opacity: 90-96

Brightness: 87

If a direct mail printer requires paper with the following attributes:

Basis Weight: 70#

Brightness: 82-87

Both Paper Company X's Velocity product and Paper Company Y's Utopia III product can be grouped as like products based on their generic attribute descriptors.

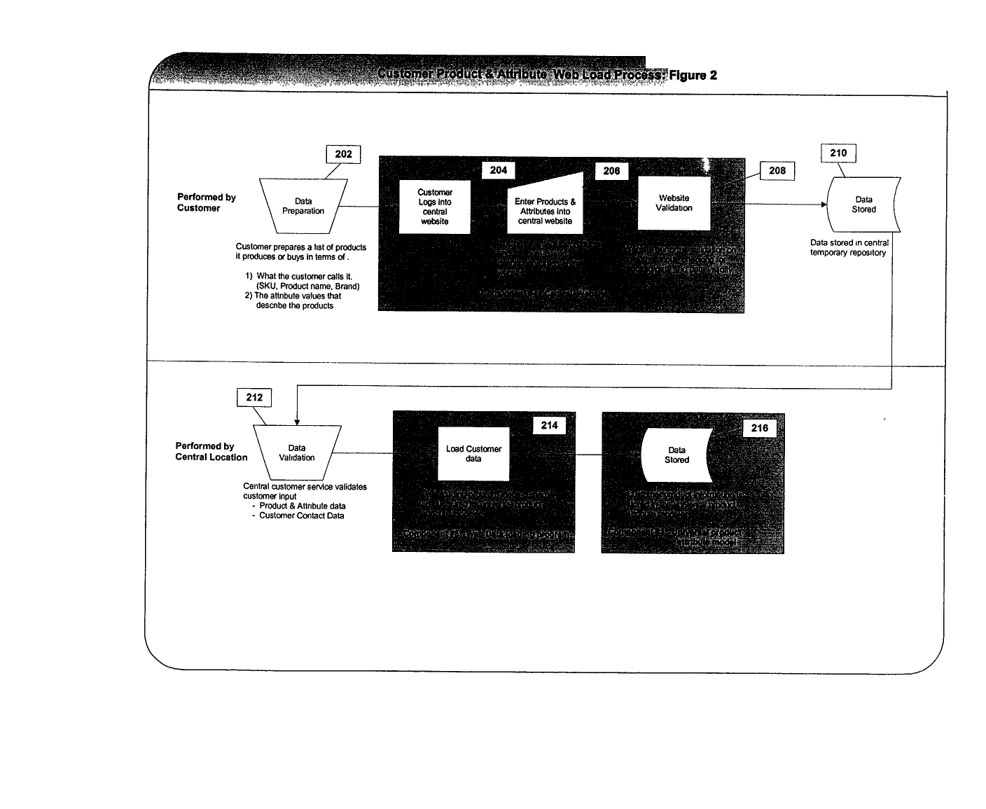

FIG. 2 is a flow diagram illustrating product and attribute web loading in one embodiment. At 202, customer, for example, prepares a list of products, such as paper related products that it produces or buys and describes the products in terms of what the customer calls it, for example, SKU, product name, or brand, and attribute values associated with the products.

At 204, the customer logs into a website provided for uploading data into the universal product attribute modeler. The product upload website is a user-friendly web-based application that allows product buyers and suppliers to describe the products that they buy and sell. The logging-in may be done, for example, through user identifier (“id”) and password validation. Any other log-in or user authentication method may also be utilized to validate a user, before allowing a user to use the system. At 206, the customer enters its products and attribute based descriptions into the web page provided by the website. At 208, the entered data is validated. The validation, for example, may be performed locally by the web page using, for example, an embedded scripting language, or by a program residing in the website server. The validation process may include checking for mandatory entries such as product description parameters and data format entries. Examples of data format entries may include date format and data type such as numeric formats. At 210, the data is stored in a temporary repository, such as a database. At 212, data is again validated for its content, such as whether the data is within a valid range, whether all required fields have been entered, and whether the data entered is meaningful for the description of the product. For example, if a basis weight of 90000# is entered, it would pass the data validation because basis weight is entered in numeric format, but there is no industry paper product with a basis weight of 90000#, and thus would not pass at 212. Thus, this data is corrected. At 214, a loading program loads customer product information into its universal product attribute model. The loading program extracts product and attribute information captured by the product upload website and loads the extracted data into the universal product attribute modeler. This loading program may be a Java and XML based application, implemented, for example, to include a presentation layer programmed in Java, XML, and HTML, and application layer programmed in Java and XML.

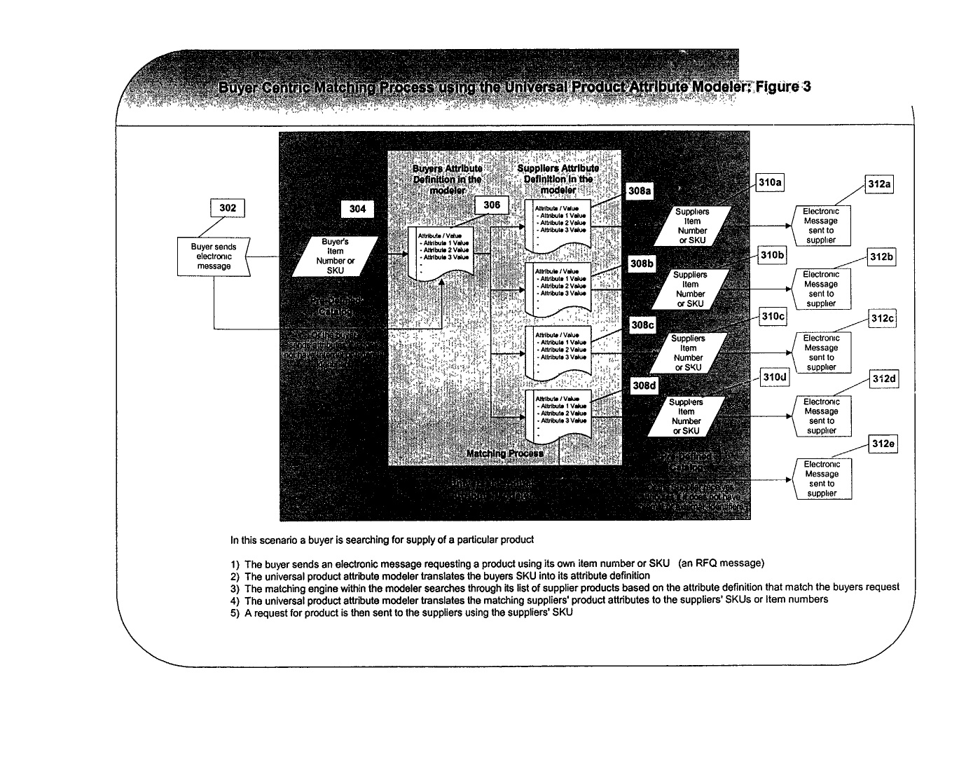

FIG. 3 is a flow diagram illustrating a buyer centric matching process in one embodiment. This matching process occurs, for example, in a scenario where a buyer is searching for supply of a particular product, for example, paper. At 302, buyer sends an electronic message requesting a product using its own item number or SKU. This item number or SKU is transmitted to the universal product attribute modeler. This message, for example, may be in a form of a request for quote (“RFQ”) message. As shown at 304, the buyer's item number or SKU is found in a predefined catalog. The predefined catalog, for example, is a partner (buyer or supplier) map that links the attribute description of paper products to a particular partner's internal or external identifiers. This information may be also mapped during the upload process of buyer or supplier product profiles.

At 306, the buyer's item number is translated into its attribute definition. At 308a-d, a search is performed, for example, by a search engine, on a list of supplier products for an attribute definition that matches the buyer's request.

The following describes an illustrative example of matching products using the modeler. For example:

A direct mail printer, a buyer, requires paper with an internal identifier called “ID123” to identify Coated Freesheet #3 with the following attributes:

Internal Identifier: ID123

Product and Grade: Printing and Writing—Freesheet #3

Basis Weight: 70#

Brightness: 82-87

The buyer may perform an attribute search using only its identifier (ID123) because the attributes are already mapped. Based on an attribute level search, the following suppliers may be returned because they match the buyer's requirements:

Company: Paper Company X

Brand: Velocity

Product and Grade: Printing and Writing—Freesheet #3

Basis Weight: 50#-100#

Opacity: 90.5-96

Brightness: 81-82

Company: Paper Company Y

Brand: Utopia III

Product and Grade: Printing and Writing—Freesheet #3

Basis Weight: 45#-100#

Opacity: 90-96

Brightness: 87

Using the results of the match, the buyer may now send an electronic message to each or any of the suppliers using the suppliers' identifier(s). In this example, the buyer may send an electronic RFQ to Paper Company Y requesting its Utopia III product.

At 310a-d, one or more matching supplier's product attributes are translated to respective supplier's item number or SKUs. At 312a-d, a request for product is then sent to each matching supplier using the supplier's SKU, item number, or any other unique identifier that the supplier uses to identify its products.

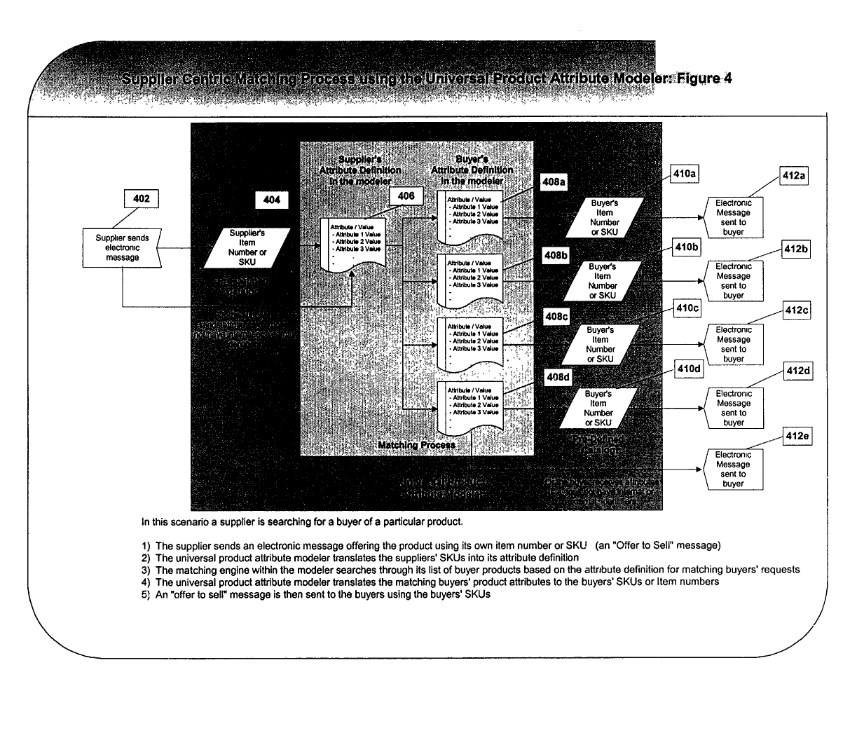

FIG. 4 is a flow diagram illustrating a supplier centric matching process in one embodiment. The process illustrated in FIG. 4, for example, occurs in a scenario where a supplier is searching for a buyer of a particular product. The product, for example, may be paper product. At 402, a supplier sends an electronic message offering a product using its own item number or SKU. This message may be referred to as an “offer to sell” message. At 404, supplier's item number is found in a pre-defined catalog. The supplier's predefined product catalog is loaded and stored in the same manner as the buyer's predefined catalog. At 406, the supplier's item number is mapped to an attribute definition in the universal product attribute modeler.

For example, Paper Company Y's Utopia III brand may be mapped to its attribute values of:

Product and Grade: Printing and Writing—Freesheet #3

Basis Weight: 45#-100#

Opacity: 90-96

Brightness: 87

At 408a-d, a search engine, for example, searches through buyer attribute definitions for products that match the supplier's attribute definitions. At 410a-d, the matching buyer's product attributes are translated into the buyer's SKUs or item numbers. At 412a-412d, an offer to sell the product is then sent to the buyers using the buyer's SKUs. It should be understood that although the buyer and supplier product identifying information was described in terms of SKUs and item numbers, any other labeling used by buyers and supplier may be used in lieu of or in addition to the item number or SKUs for such purposes.

FIG. 5 is an architectural diagram illustrating software components that implement the method and system for universal product attribute modeler in one embodiment. Product upload application program 502, for example, may be a user-friendly spreadsheet application such as Microsoft Excel. The spreadsheet application 502 allows suppliers and buyers to describe their products based on the product attributes. That is, suppliers and buyers may enter on the spreadsheet the buyer and supplier specific identification for the product, and the product's attributes. The buyer and supplier specific identification may include buyer or supplier unique SKUs or brand names. The spreadsheet application 502 may perform validation checks on the data entered by a user of the spreadsheet. As described above, users may include all types of suppliers or buyers.

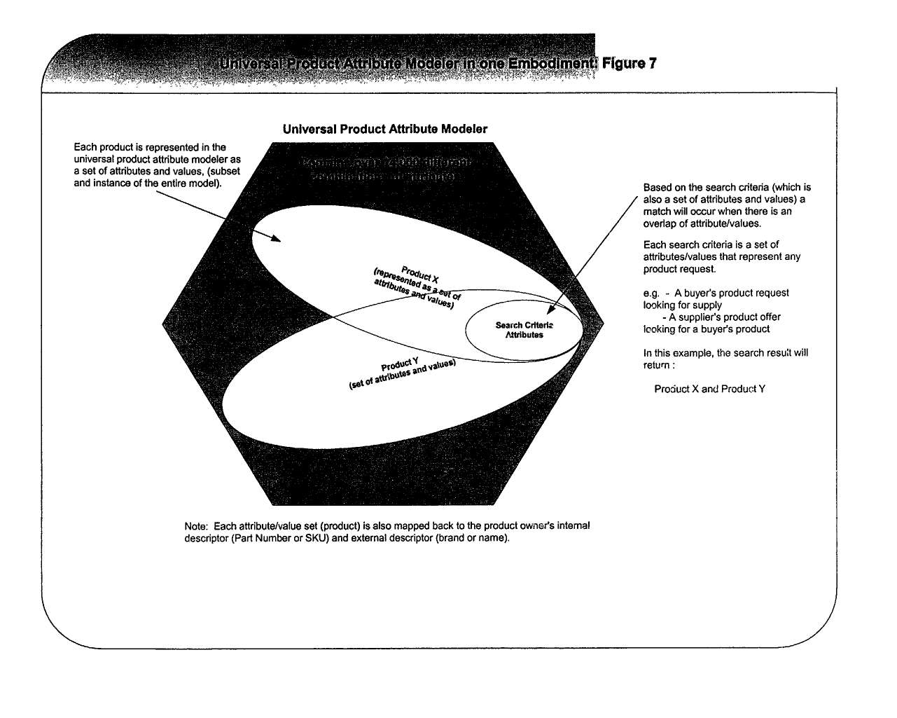

The data loading program 504 loads the data from the spreadsheet into the attribute modeler 506. The attribute modeler 506 includes a data layer that may be a relational database where the product identification and attribute descriptions are stored. The attribute modeler further may include an application layer. The application layer of the application may include logic or code between the presentation layer and data layer. This code may include matching algorithms and logic to describe the attribute data model in a hierarchical form that may be used for matching and translation. It also may include a logic to translate user requests from the presentation layer to query the attribute modeler. An example of how the application layer translates a user request into search criteria will be described further with reference to FIG. 7.

The attribute modeler also may include a presentation layer that includes software components that interact with the application layer to present data and functionality to the end user. The end user interacts with the presentation layer to access the application layer. The presentation layer includes, for example, software that describes the user experience. An illustrative example includes the use of an XML style sheet to convert one HTML page format to another based on the user's logon and preferences. For example, if a user sets preference information to work in the French language and use metric units of measure, the presentation layer ensures that the display information is formatted according to the user's preference.

Similarly, a website product upload application 508 includes a spreadsheet application or a web entry form for entering data via the Internet. Data file such as spreadsheet may be uploaded via the Internet, or the data may be directly entered on a web page. Validations may be performed by the spreadsheet application or a scripting language embedded in the web entry form, for example an HTML page.

In one embodiment, the universal product attribute modeler is implemented using a plurality of software layer interacting with one another. These components include a presentation layer, application layer, and data layer.

The presentation layer, for example, refers to the software, regardless of programming language, that controls the user interface through which end users view or manipulate data. In a web-based implementation of the universal product attribute modeler, this layer may be responsible for generating the HTML behind a web page.

The application layer, for example, refers to the software, regardless of programming language, that includes the logic to match attributes, search on attributes and translate attributes. This layer communicates with the presentation layer and data layer.

The data layer is where the data is physically stored before and after manipulation by the application layer. This layer may include the relational database where the attributes and values are stored.

Although a product upload application 502 and a website product upload application 508 are shown as separate components in FIG. 5, it should be appreciated by those skilled in computer programming that one upload application program may handle both data loading functionalities.

A website product data loading program 510 extracts product and attribute information captured by the product upload website 508. The website product data loading program 510 also loads the extracted data into the universal product attribute modeler 506. In one embodiment, this program 510 may be implemented to have a presentation layer programmed in Java, XML, and HTML, and an application layer programmed in Java and XML. The presentation layer, for example, may be a HTML web page that allows a supplier to enter its products and attributes or an HTML page that allows a buyer to enter the search criteria based on his or her internal numbers. The application layer, for example, builds the queries and formats the data to be read, updated or stored in the relational database. An illustrative example includes building an SQL statement to run against a database to query supplier products based on a buyer's attribute criteria.

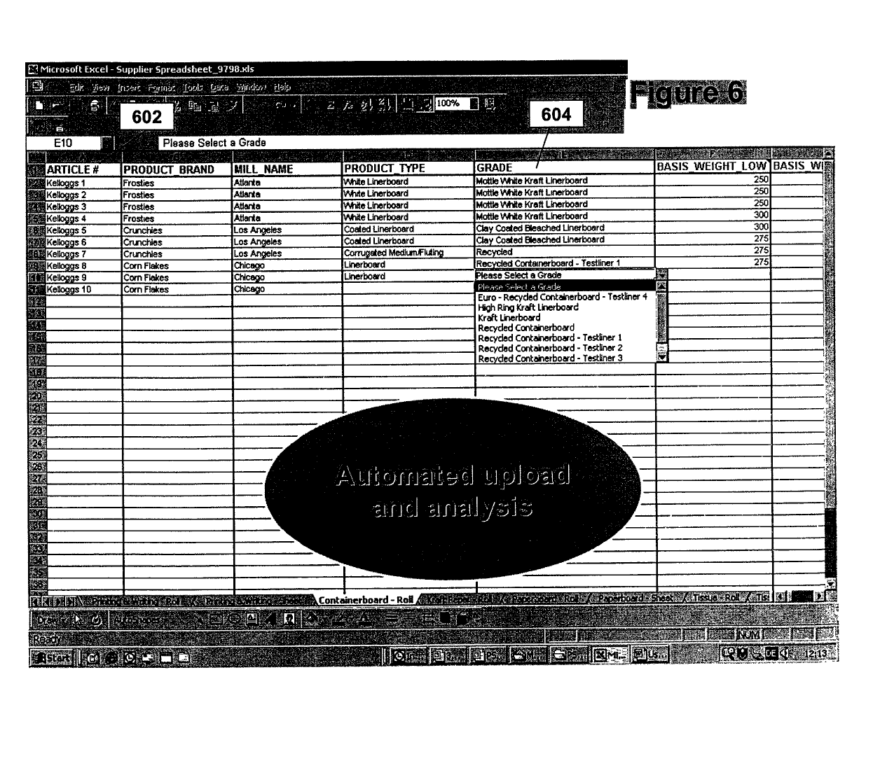

FIG. 6 is an example of an entry form in one embodiment. The entry form shown in FIG. 6 is Microsoft Excel spreadsheet. A supplier, for example, enters the attribute data (column B- . . . , etc.) 504 associated with its products shown in column A 502. The attributes include, for example, product_brand, mill_name, product_type, grade, basis_weight, etc.

FIG. 7 shows an example of how the application layer translates a user request into search criteria in one embodiment. A user's request, for example, identified by an identifier, is mapped to a set of attribute values. The set of attribute values are then used as search criteria 702. The application layer then builds an attribute matching query that is run against the data layer 708. The results of the search criteria in this example are the attributes and values of Paper Product X 704 and Paper Product Y 706. The application layer then traverses through the attribute hierarchy and maps, for example, in a predefined catalog to determine the supplier unique identifier. These identifiers are then returned to the presentation layer as results to the end user.

While the invention has been particularly shown and described with respect to particular embodiments thereof, it will be understood by those skilled in the art that the foregoing and other changes in form and details may be made therein without departing from the spirit and scope of the invention.

We claim:

1. A method for facilitating buying and selling of products wherein buyers and suppliers use different identifiers for similar products, comprising:
receiving a first identifier for a product and first one or more attributes describing the product from a first party;
storing the first identifier, the first one or more attributes, a first party identifier associating the first party in a data model;
receiving a second identifier for a product from a second party;
determining one or more attributes associated with the second identifier;
storing the second identifier, the second one or more attributes, a second party identifier associating the second party in the data model;
receiving a request for a product;
determining one or more attributes associated with the requested product;
searching the data model for one or more matching products having the one or more attributes associated with the requested product; and
if found, providing one or more parties' identifications associated with the one or more matching products.

2. The method as claimed in claim 1, wherein the providing includes providing the one or more matching product.

3. The method as claimed in claim 1, wherein the product is forest product.

4. The method as claimed in claim 1, wherein the product includes one or more products that can be described by attributes.

5. A method of providing universal product attribute modeler, comprising:
receiving a plurality of supplier product identifiers and associated supplier product attributes from a plurality of product suppliers;
automatically loading into a data model, the plurality of supplier product identifiers, the plurality of product suppliers, and the associated supplier product attributes;
receiving a plurality of buyer product identifiers and associated buyer product attributes from a plurality of product buyers;
automatically loading into a data model, the plurality of buyer product identifiers, the plurality of product buyers, and the associated buyer product attributes;
receiving a request for a product identified by buyer's product identifier;
determining one or more product attributes associated with the buyer's product identifier; and
searching the data model for a product having the one or more product attributes associated with the buyer's product identifier,
wherein a buyer is automatically provided with one or more products and one or more suppliers according to buyer's product attribute requirement, regardless of one or more product identifiers used by supplier and buyer.

6. The method of claim 5, wherein the product is forest product.

7. The method as claimed in claim 5, wherein the product includes one or more products that can be described by attributes.

8. The method of claim 5, further including:
providing predetermined spreadsheet to a supplier for entering supplier's product attribute data; and
the automatically loading includes automatically loading the supplier's product attribute data from the predetermined spreadsheet.

9. The method of claim 5, further including:
providing predetermined spreadsheet to a buyer for entering buyer's product attribute data; and
the automatically loading includes automatically loading the buyer's product attribute data from the predetermined spreadsheet.

10. The method of claim 5, further including:
receiving an offer for product identified by a supplier's product identifier;
determining one or more product attributes associated with the supplier's product identifier; and
searching the data model for a buyer requesting a product having the one or more product attributes associated with the seller's product identifier,
wherein the supplier is automatically provided with one or more buyers requesting a product having the one or more product attributes associated with the supplier's product identifier.

11. A method for coordinating communication between one or more parties wherein the one or more parties use different identifiers for referring to similar products, comprising:
receiving a first identifier for a product and first one or more attributes describing the product from a first party;
converting based on the first one or more attributes the first identifier to a first standard identifier identifying the first identifier;
storing the first identifier, the first standard identifier, and the first one or more attributes in a data model;
receiving a second identifier for a product and second one or more attributes describing the product from a second party;
converting based on the second one or more attributes the second identifier to a second standard identifier identifying the second identifier;
storing the second identifier, the second standard identifier, and the second one or more attributes in the data model.

12. The method of claim 11, wherein the first standard identifier and the second standard identifier are the same based on what the user defines as same.

13. The method of claim 11, further including:
receiving a request for a product identified by an identifier;
translating the identifier into a standard identifier;
searching the data model for the standard identifier; and
providing a party identifier associated with the standard identifier.

14. A system for coordinating communication between one or more parties wherein the one or more parties use different identifiers for referring to similar products, comprising:
a data entry module for capturing product and attribute information;
a data load module for uploading the product and attribute information; and
a universal product attribute modeler for storing the product and attribute information, the universal product attribute modeler including a search engine enabled to search data stored in the universal product attribute modeler according to one or more product attributes.

15. A program storage device readable by machine, tangibly embodying a program of instructions executable by the machine to perform method steps of coordinating communication between one or more parties wherein the one or more parties use different identifiers for referring to similar products, comprising:
receiving a first identifier for a product and first one or more attributes describing the product from a first party;
converting based on the first one or more attributes the first identifier to a first standard identifier identifying the first identifier;
storing the first identifier, the first standard identifier, and the first one or more attributes in a data model;
receiving a second identifier for a product and second one or more attributes describing the product from a second party;
converting based on the second one or more attributes the second identifier to a second standard identifier identifying the second identifier;
storing the second identifier, the second standard identifier, and the second one or more attributes in the data model.
